(19) United States
(12) Patent Application Publication
(10) Pub. No.: US 2008/0052095 A1
(43) Pub. Date: Feb. 28, 2008

(54) System and method for facilitating a low cost real estate transaction using a Multiple Listing Service (MLS)

(76) Inventor: Steven Neil, Surrey (CA)

Correspondence Address: STEVEN NEIL, 14199 32A AVE, SURREY, BC, V4P 3P4, US

(21) Appl. No.: 11/507,250

(22) Filed: Aug. 22, 2006

(51) Int. Cl. G06Q 10/00; G06Q 30/00

(52) U.S. Cl. 705/1

(57) ABSTRACT

A system and method for reducing the cost of a real estate transaction while still employing a real estate agent, and still listing properties on websites disallowing the general public to list property for sale (or for lease) directly. Communication between seller and buyer is encouraged and payments to the real estate agent are in small installments proportional to the service supplied, rather than proportional to the selling price of the property.

### BACKGROUND OF THE INVENTION

The current real estate buying and selling process does not take advantage of technological advances to reduce the cost of the real estate transaction and actively discourages direct contact between buyers and sellers. Through its' member boards and associations, the MLS® system has grown to overwhelming status over time and has become so firmly entrenched in society that it now enjoys a virtual monopoly for the marketing of real estate in North America. As an example, www.mls.ca receives more than 4 million page views per day. As no other medium can give property sellers anywhere near this type of exposure, people feel compelled to use the MLS system, and pay high commissions to real estate agents to gain access to this closed system.

The MLS system was developed before the internet, e-mail, and other advances in technology were conceived. These same advances in technology have reduced the cost of services in most other industries, such as the travel industry, banking and financial services, and stock trading etc. The MLS system continues to use its dominant position in the marketplace to position the real estate agent at the center of the real estate transaction and maximize the real estate agent involvement in the transaction. It does not take full advantage of advances in technology to maximize savings to property sellers, and discourages any direct contact between buyers and sellers, all of which inflates the cost of the real estate transaction to the detriment of buyers and sellers.

The real estate boards and associations have also used their dominant position with the MLS to maintain its antiquated pricing model to the detriment of consumers. The current pricing model charged to the vast majority of sellers to gain access to this closed MLS system is based on a percentage of the ultimate selling price of the property. There are, however, increasing numbers of “flat fee” MLS service providers in the marketplace as well. However, the up front MLS flat fee does not provide the flexible payment options for property sellers who only want or need the property listed on MLS for a short period of time (say 1, 2, or 3 weeks), rather than the customary two months, or other relatively long period of time for which it is necessary to commit to for an MLS listing. The percentage based commission structure was developed decades ago when the ratio of home prices to salaries was very low in comparison to today. With the inflation of real estate prices over time, above and beyond average inflation, this system of how property sellers are charged to access the MLS has not changed and has become a significant cost in the real estate transaction. This is particularly disadvantageous to those with low equity positions who rely to a large degree on financing for their property ownership. The current payment method involves payment made to real estate agents from trust deposits, held by either a lawyer or by the real estate agent or escrow agent, and any deficiency is paid out of the proceeds of the sale on the closing date.

In the current MLS listing process a real estate agent meets with a prospective seller (which could be a seller of a residential home, commercial building/strata space, commercial office, or retail or warehouse space for lease). The real estate agent assists the seller in completing the standard real estate board MLS forms which are usually comprised of one or more of the following: Multiple Listing Service contract, Data Input Sheets (to contain information on the property), and an Agency Disclosure Form, or Working With A Real Estate Agent form. The type and number of forms depend on the real estate board requirements in the area in which the property is located, and the type of real estate being sold (or leased). The completed MLS forms are signed by the seller and the real estate agent (the real estate agent acting as the Listing Agent). A copy of the MLS contract is given to the seller, a copy is sent to the relevant real estate board, and a copy is retained by the Listing Agent. The real estate board then enters the data from the completed listing forms on to a computer data base. Other real estate agents can then access detailed information on the properties within a real estate agent only website.

There is no direct contact between buyers and sellers. The general public can also access only a portion of the information on a separate public real estate website which publishes only the listing real estate agent's contact information, so as to encourage the members of the public to contact the listing real estate agent to obtain more specific information on the property, and to make appointments to view the property through the listing agent. The system is designed to place the real estate agent at the center of all real estate transactions, and discourages any direct contact between buyers and sellers. Currently all communication is generally between Listing Agents and Buyers Agents, the latter being real estate agents representing the buyers in the transaction, with again no direct communication between buyers and sellers.

Offers are drafted by Buyers Agents and presented to the Listing Agent. The Listing Agent then presents the offer to the seller for consideration. Any counter-offers are drafted by the Listing Agent, and then presented to the Buyers Agent, who then presents the counter-offer to the buyer. This process, which maximizes the real estate agent involvement, continues until an accepted offer is obtained. Copies of the accepted offer are distributed to all parties involved, including both Listing Agent and Buyers Agent. The Buyers Agent then usually obtains a deposit from the buyer, which is then placed in a real estate agent trust account (or similar trust account) and is held as a stakeholder, and forms part of the purchase price on the completion date for the sale of the property. If subjects or conditions are to be removed prior to the accepted offer becoming binding, the buyers and sellers will initiate actions to satisfy any conditions within a specified time frame. If and when all subject conditions are satisfied, the Buyers Agent will in most cases prepare a subject removal form using a standardized real estate board form, have the relevant parties sign the subject removal form, and distribute copies to all parties. From here the buyer and seller will have their respective lawyers or notaries complete the documents necessary to receive the funds and complete the property transfer.

The current signage process is for real estate agents who list properties to place their own signs on the property with their own contact information, sometimes including the MLS number. The purpose here is to place the real estate agent in the position of middleman, controlling all contact with potential buyers so that there is no direct contact between buyer and seller. This continues to position the real estate agent in a high involvement and high control position, the results of which are very inflationary to the cost of the real estate transaction.

U.S. Pat. No. 6,751,596 is a system and method for tracking, monitoring, and supporting self-procurement of an individual for the purchase of a home. As a self-procuring principal (SPP), the individual would be entitled to the real estate commission payable to licensed real estate agents. To aid the SPP in his self-procurement activities, the system provides information to the SPP of property listings that match the SPP's search criteria. The system also provides comparable sales information of other homes in the area, school district reports, environmental hazard reports, and automated offer drafting assistance. If the SPP wants to view a property, the system coordinates such viewing by contacting chaperones to provide the showing of the property. The SPP's self-procuring activities are tracked by the system for inclusion in the SPP's loan file. The report certifies that the SPP has indeed represented and procured himself, and thus, is entitled to the real estate commission. The SPP can then apply the commission towards the down payment of a home. This goes some way towards recognizing that real estate agent fees are too high by providing a system in which a purchaser can act without an agent and recover the commission allocated by the seller to a buyer's agent. However, this method typically only benefits the buyer since the seller is still required to pay the Listing Agent a large commission.

U.S. Pat. No. 6,594,633 is a ‘for sale by owner’ system to reduce or eliminate the need for a seller and a buyer to work through real estate agents. It discloses a real estate computer network which facilitates a real estate transaction between a buyer and a seller by electronically communicating between the parties and third parties such as a real estate facilitating entities (e.g., lawyer, mortgage provider, title provider) over a network, such as or including the internet. Each stage of the transaction is supported by the parties utilizing an online real time interactive communication interface to list property information; to search for a property in a property database; to negotiate via an electronic purchase contract; and to schedule associated events (e.g., showings) and deadlines (e.g., closing, mortgage filing). Other real estate services are supported, such as electronic mortgage calculator, electronic mortgage application, searching for comparable sales, electronic document delivery, and others. It allows an interactive search engine for the buyer or the seller to find comparable sales to the selected property to assist in determining a market price. This is typically a service requiring a real estate agent or a real estate appraiser and is generally not available to the public. Consequently, this feature may be deemed an enhanced service for which an additional fee is secured. Another associated service is an “ask the agent” object, which may be deemed an enhanced service warranting additional fees. Marketing information may be sent to the seller, such as signage and guidelines for making a home presentable for a showing, which may also be deemed an enhanced service. However, this “for sale by owner” system does not have the volume of listings, national exposure, or dominant position in the marketplace that the MLS system has established.

US patent application publication no. 2005/0246273 describes a method of providing online sales of properties by owners. The method includes placing an advertisement for a property; providing a secure log in for a seller of property; providing a secure log in for a buyer of property; providing a database of properties for sale by the sellers; providing a plurality of seller functions; and providing a plurality of buyer functions. It also allows real estate agents to place advertisements of their listings on the site, but it does not allow home sellers to place their advertisements on sites restricted to real estate agents, such as MLS controlled sites.

US patent application publication no. 2006/0015451 describes methods, devices, and systems for property transactions. One device embodiment includes a processor, a memory coupled to the processor, and user interface coupled to the memory and processor. The device includes program instructions storable in memory and executable by the processor to coordinate a buyer electronic indicator and a seller electronic indicator associated with a piece of property in order to culminate a transaction. It has an MLS “My Neighborhood” Market Activity link which allows sellers to adjust the frequency with which they receive email updates regarding their neighborhood real estate market activity.

US patent application publication no. 2005/0278204 discloses an integrated system for the sale of personal possessions in conjunction with a home. When engaged by a homeowner, a real estate agent can provide optional sales channels for personal possession associated with the existing home that the homeowner may no longer need or want. Providing significant convenience to the homeowner, the real estate agent/auction entity takes care of all or most of the details with respect to the sales of the goods and generally delivers the money minus commissions to the homeowner. This includes cataloguing the items for sale both visually and verbally as well as obtaining minimum price information from the homeowner. Storage services may also be provided if necessary for the homeowner by the real estate agent/auctioning entity.

US patent application publication no. 2004/0039581 describes a system for managing the sale of real estate that includes a first step of providing a computer server that is accessible via a global computer network. In a second step there is provided on the computer server a real estate database that contains property listings that are being offered for sale by real estate agents and independent sellers. In a third step there is provided on the computer server a transaction database that is adapted to store sale documentation relating to the sale of a real estate listing. In a final step, sale documentation relating to a property listing is received in the transaction database. The transaction database is then automatically updated so that a buyer and dealer and others can monitor the progress of a sale.

US patent application publication no. 2004/0133493 discloses a method and system for comprehensively managing real estate transactions through a network from inception of a sale or purchase through listing, purchasing, closing and post-closing activity. Participants or potential participants in a real estate transaction can access, generate, modify, distribute and sign real estate-related documents, information, and reports through a network while communicating with each other electronically. Participants or potential participants can also track the development of a real estate transaction and receive automatic notification of changes in the development.

Access to the system's various features can also be restricted to certain transaction participants or potential participants. It describes how the transaction management system could be incorporated into an MLS website.

US patent application publication no. 2002/0069151 describes an internet real estate auction with a buyer pre-approval method. For a fee, sellers post listings on an auction web site. Buyers browse the listings, and apply for loan pre-approval from lenders. Lenders pre-approve buyers and issue them passwords, so that the buyers can bid on listed properties. Bids are transmitted from the buyers to the sellers through the auction web site. If a seller wishes to accept a bid, he transmits his acceptance to the buyer through the auction web site. The buyer answers with a confirmation, downloads a sales contract, executes the sales contract, and delivers the executed sales contract along with a deposit to an escrow agent. An escrow agent real estate attorney reviews the sales contract, makes any necessary changes, and sends the final sales contract to the buyer and seller for execution. The auction web site operator may provide additional fee-based services such as the provision of signage, lockboxes, and/or pictures to the seller to aid in the sale of the seller's property.

US patent application publications no. 2002/0165726 and no. 2003/0187756, and PCT international publication nos. WO 00/62220 and WO 2004/107223 describe systems and methods for facilitating the creation and management of contracts and documents online.

In some cases, people sell their homes by owner in order to completely avoid dealing with a real estate agent. There are several FSBO (For Sale By Owner) internet companies which facilitate this process. The FSBO method requires a lot of work by the seller, and many potential sellers do not have the confidence to manage their own sale.

No one has ever charged for MLS services before using a repetitive fee structure, such as monthly, weekly, daily, or a fee structure in unequal installments, perhaps on a declining basis, or a fee structure tied to the amount of activity, such as the number of page views on the MLS searches for the property.

In the prior art described the seller's contact information (or optionally providing information to potential buyers on where or how to obtain the sellers contact information) has not been placed on public MLS websites. The obvious reason it has never been done before is because it is contrary to the goal of the real estate agent who desires to position himself or herself as a middleman, maximizing their involvement in the real estate transaction, controlling all contact between buyers and sellers, and consequently maximize the large commissions which are common in the industry.

The placement of a link or a URL (web address), or information in the public remarks on an MLS website (including a web site that is affiliated whether through partnership or some other agreement or arrangement that allows MLS and it's member boards and licensed Realtors some form of control or influence over the web site) that would allow or lead potential buyers to a secure website to prepare electronic offers and/or bids on an MLS listing has never been done before.

An owner placing their own sign on their property (even though the property is listed on the MLS), and combining property owner contact information with the MLS number on the sign, and allowing a prospective buyer to contact the owner directly (and or retrieve information on how to place an online offer or bid on the property) via use of the MLS number is innovative because this has never been done before, as it generally lessens the involvement and the control of real estate agents over the real estate transaction, and will likely lead to reduced fees charged by the real estate agents. Also, providing information on a sign, on where and or how, buyers can place an online offer or bid on a property for an MLS listing has not been done before.

### SUMMARY OF THE INVENTION

This invention is a new and innovative method and system, whereby consumers will be able to access the Multiple Listing Service (MLS) system for the buying and selling of real estate, and substantially reduce the cost of real estate transactions. The invention features increased use of technology to create efficiencies and streamline the buying and selling process, increased direct contact between buyers and sellers, and a reduced role of the real estate agent. The pricing model and payment method for this new method and system saves sellers thousands of dollars, as sellers are charged based on time of use, the amount of activity received on a particular listing, or a combination of both time and activity, rather than a percentage of the final selling price or a flat fee. This creates greater affordability, flexible payment options, and does not require large upfront payments.

An innovative use of the MLS public website(s) is disclosed to promote and maximize direct contact between buyers and sellers (thereby reducing the amount of work generally performed by the real estate agent) and substantially reducing the cost of the real estate transaction which would normally be inflated by a real estate agent acting as a middleman.

The completion of the MLS listing forms can be done by the seller without the need for an in person meeting with a real estate agent. The seller can either download the listing forms from a website, or call a 1-800 number to have the listing forms sent by e-mail, for example. The listing forms could also be completed online with the help of a “Listing Wizard” that guides the seller through the completion of the forms. If assistance is needed the seller can also reference a website or call a help line. This method of completing listing forms has never been used before for MLS. This new method for completing listing documentation is useful because it saves time, and therefore cost, as it eliminates much of the time required to have the real estate agent go to the seller's home and assist them, and most of the work of completing the listing forms is done by the seller.

Electronic offers and or bids are permitted to reduce the cost of the real estate transaction because they save time and eliminate or reduce a real estate agent's involvement in the transaction.

A new signage process is introduced which encourages direct contact between the buyers and sellers. This is contrary to current real estate practice, as direct contact between buyers and sellers is discouraged, and only real estate agent contact information is placed on real estate agent signs for MLS listings. Sellers will have the option of placing their own sign on their property with their contact information, and the MLS number. Sellers will have the option to place a 1(800) number on the sign that will allow potential buyers to enter the MLS number and have the call redirected to the seller, retrieve pre-recorded information on the property, retrieve pre-recorded information on how to place an online offer or bid on the property, download information about the property, have the call redirected to the listing real estate agent, or leave a message). Sellers will also have the option to place information on the sign (including a web site address) informing potential buyers where and how they can make an online offer or bid on the property.

### BRIEF DESCRIPTION OF THE DRAWINGS

FIG. 1 shows a flowchart of the method

FIG. 2 shows a simplified view of the system

FIG. 3 shows a sign

### DETAILED DESCRIPTION OF THE INVENTION

The new real estate buying and selling system and method takes full advantage of technological advances to streamline the real estate transaction and encourages direct contact between buyers and sellers. It combines the power of technology, innovative business methods, and the dominant position of the MLS to reduce the costs of the real estate transaction.

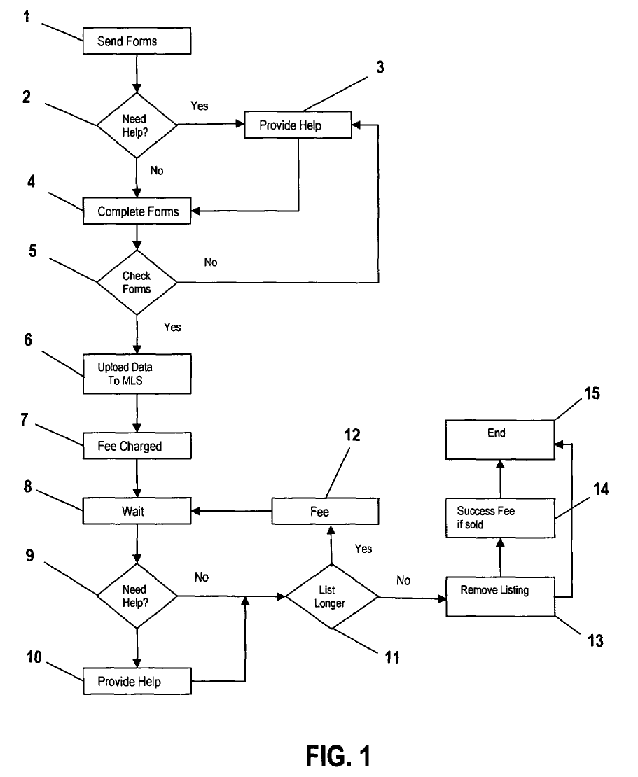

In a preferred embodiment of the new property listing method, shown in FIG. 1, a real estate agent sends real estate board MLS listing forms 1 to sellers via e-mail, fax, mail, or they can be downloaded directly from a website, or completed online using fillable forms (possibly with a form “Listing Wizard”, or through the use of “pop ups”). If the seller needs help 2 to fill them in, optional assistance 3 can be found in a “guide to completing the forms” found on the website, or they can optionally call the helpline for technical assistance. The helpline may be a free, 1-800 number for example. Sellers then fill in 4 the MLS listing forms on their own, and send them back to the real estate agent who checks that they are complete and ready for submission to the relevant real estate board 5. As part of completing the forms, the seller has the option to decide whether or not, and if so the amount of, any commissions or fees that are offered to real estate agents who bring buyers or offers for the property. If the forms are not complete, the real estate agent follows up with the seller (by phone or other means of remote communication) if necessary regarding any deficiencies, and further help 3 can be provided. Then, through the relevant real estate board, the real estate agent then lists the property for sale 6 and enters the seller's contact information (or optionally information on where or how buyers might obtain the sellers contact information) on an MLS website, agreeing that the property should appear on MLS for an extended duration of time, such as 60 days, 90 days or 120 days, and only charges a fee 7 which corresponds to having the property listed on MLS for a shorter duration of time, for example one week, two weeks, or three weeks. In this method the benefit to the property seller is that the property seller only has to pay for the length of time that the listing services are received, and the benefit to the listing agent is that the MLS listing does not need to be renewed every week, or other relatively short duration, which would add unnecessary administrative burden and costs to the process.

Once the listing information is entered into the MLS database and posted on the public MLS website(s), potential buyers can readily see the seller's contact information (or will see information on where and or how to obtain the sellers contact information) and can contact the seller directly regarding any showings (or for information) regarding the property. Note that with the creation of the internet, statistics now demonstrate that the overwhelming majority of potential buyers now complete their home buying research on the web using the public MLS websites. Direct contact between buyers and sellers is encouraged because the new method and system places the seller's name and contact information (or information on where and or how to obtain the sellers contact information) in the public internet remarks that are ultimately published on the MLS public website(s) so that all prospective purchasers are aware of the seller's contact information. This reduces the real estate middleman involvement, and therefore reduces the cost of the real estate transaction for consumers.

The new pricing model and payment process according to a preferred embodiment is extremely low, and takes full advantage of new technologies to maximize savings in the real estate transaction. Fees charged are based on the length of time a property is listed, or optionally the amount of activity received on a particular listing (i.e. the number of times the property is searched, the number of times the property page is viewed, or the number of times the hyperlink 28 described below is clicked), or a combination of both time and activity on the listing, rather than percentage based or flat fee. As an example the fee might be $99 per month, $29 per week, $4 per day, 0.5 cents per minute or 25 cents each time the property listing page is viewed, and will be charged directly to the customers VISA card, MasterCard, other credit card, direct deposit card, or other form of e-commerce transaction. This creates greater affordability, flexible payment options, and does not require large upfront fees or commissions. In the preferred embodiment of FIG. 1, a nominal initial listing fee 7 (for example say $100 or $200), may be charged for listing the property on an MLS website(s).

The fees may be split into an initial listing fee, a repetitive fee (dependent on the duration the property is to be listed on the MLS), and a success fee upon the sale of the property. Any combination of these fees may be possible.

After an elapsed period of time 8 the Listing Agent determines whether the seller requires assistance 9, and if so provides it remotely 10. The help required may be that from the Listing Agent, or a service provider other than a Listing Agent, such as a lawyer, a real estate consultant, or a mortgage adviser, in which case the website provides the relevant help, contact numbers, email addresses, numbers (or possibly use Voice Over Internet Protocol) of relevant service providers who can provide the required assistance.

Also, after the elapsed period of time 8, the Listing Agent determines whether the seller wants to continue to list the property 11 on the MLS website, and if so, charges a continuation fee 12. The steps of providing assistance and renewing the listing can be repeated several times.

When the Listing Agent has determined that the seller no longer wishes to continue to list the property on MLS, either because the property has been sold, or for other reasons, the Listing Agent removes the listing from the MLS 13. If the property listing has ended because the property has been sold, the Listing Agent may charge a success fee 14 after which the process ends 15. The success fee would typically be substantially lower (for example say $500) than the usual commission charged by real estate agents (which might be for example 10, or 20 times larger than the success fee depending on the sale price of the property), this is because the seller has been able to do much of the work a real estate agent would usually do.

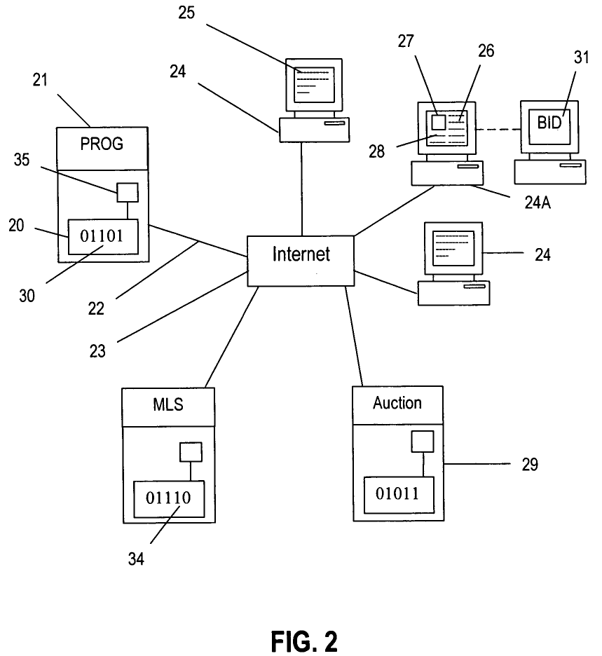

Referring now to FIG. 2 we see a simplified diagram of a preferred embodiment of the system of the present invention. The system comprises a computer-readable medium 20 in a server 21, connected 22 to the internet 23, which in turn is connected either with wires or remotely to a plurality of remote terminals 24. A program 30 resides in the computer readable medium 20, written in a language such as HTML, PHP, ASP, SQL or any other computer programming language and is capable, when run by a processor 35, of providing web content to be displayed in web browsers on remote terminals. The program is configured to display information on a remote terminal 24 including a list 25 of one or more names of MLS or other restricted or real estate agent affiliated or controlled websites, which disallow property sellers to post their own property listings for sale directly without listing their property with a licensed real estate agent.

The program can accept inputs from said remote terminal including an input from a property seller indicating that the property seller wants to sell a property. If there are two or more MLS or other restricted websites listed, the program can accept an input or inputs from the property seller indicating which of the MLS or restricted websites should be used for listing the property.

After the necessary property information has been received from the seller and uploaded to the MLS database 34 and website(s), a home buyer can observe at least part of the uploaded information on another remote terminal 24A. The uploaded information which is intended for the general public to see includes the seller's contact details (or information on where or how to obtain the sellers contact details) 26, the property details 27, and optionally a hyperlink or web address (also optionally including instructions to potential purchasers to click on the link, or visit the web address if they wish to make an offer, make a bid, or communicate with the seller) 28 pointing to a website 31 through which a buyer may make an offer, make a bid, or communicate with the seller. This website may be a secure website, and may be generated by the program 30 or it may be an independent website provided by another server 29. The new communication process is therefore facilitated by: allowing buyers to click on the link placed on the MLS listing page, or by providing information on the MLS listing page that will direct buyers to a website in order to make an offer, make a bid, or communicate with the seller.

In the new offer process, once a buyer is found who is interested in placing an offer, a buyer will have several options to prepare the offer. If the buyer is working with a Buyer's Agent, the Buyer's Agent will prepare the offer. However, if the buyer is dealing directly with the seller, the buyer will have the following four options:

A—the buyer will be able to click on a link 28 or other link on the MLS listing page on the public MLS website containing the property listing. The link will take them to a website that will put the buyer in contact with a real estate agent, a real estate consultant, a real estate lawyer or a notary public who will prepare the offer for the buyer.

B—the buyer will be able to obtain standardized real estate board contracts of purchase and sale by calling a phone line and requesting them, or by downloading the contracts (possibly with a “Guide to Completing the Contract/Offer”) from a website. The contracts, if requested by phone, will be sent to the buyer via e-mail, mail, courier or fax. Buyers will also be able to call a phone line for assistance in preparing the offer.

C—the buyer will also be able to click on a link 28 or other link on the MLS listing page on the Public MLS website containing the property listing. This link will take them to a website that will guide them through the preparation of an online offer using standardized real estate board contracts, and standard real estate board approved clauses. The offer will be completed online as a fillable form or document, and may use an offer guide, pop ups, or an offer wizard to assist the buyer in completing the offer. The completed offer can be printed signed and presented to the seller in person, or can be printed, signed, and scanned for electronic delivery to the seller via the internet using email. Digital signatures can be used to streamline the process where legally possible.

D—If the particular listing is being sold using an auction method. The buyer is able to click on a link 28 or other link on the MLS listing page (or see information directing the buyer to the auction) on the public MLS website containing the property listing. The link will take them to a website that will allow the buyers to make bids (or offers) via an auction process electronically over the internet.

Note: wherever the placing of such a link or hyperlink is not allowed then the display of a web address (or information that will lead the potential buyer to the web site) will suffice.

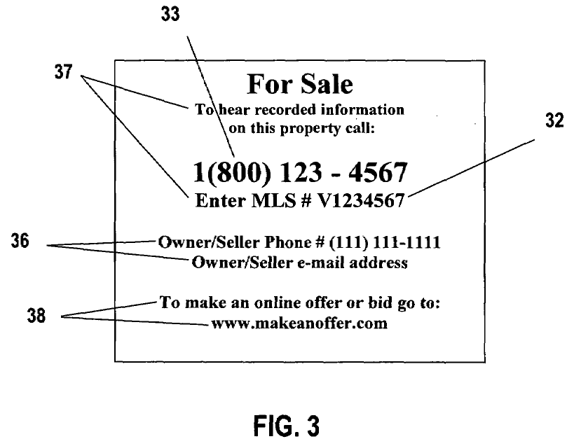

As shown in FIG. 3, the new signage allows the owner to place his/her own sign on the property, (even though it is an MLS listing), with optionally his/her contact information 36 along with the MLS number 32, so that the owner can receive any calls directly from prospective buyers. This encourages direct contact between buyer and seller, and buyers will be able to look up the MLS number from the sign to get more detailed information without engaging a real estate agent middleman to provide unnecessary or unwanted services (or solicitations) which will likely inflate the cost of the real estate transaction. Sellers will also have the option of placing a 1(800) number on the sign. When called by potential buyers, the telephone number 33 plays a message which prompts for the MLS number 32 then gives a choice of options comprising one or more of: listening to pre-recorded information about the property; speaking to the property seller, listening to pre-recorded information on how to make an online offer or bid on the property, downloading information about the property, speaking to a real estate agent; and leaving a message. Sellers will have the option of placing instructions 37 on the sign that direct potential buyers to specifically call the 1(800) number and enter the MLS number to retrieve the pre-recorded information on the property. Sellers will also have the option to place information 38 on the sign (including a web site address) informing potential buyers on where and or how they can place an online offer or bid for the property.

Note: Where the terms “seller”, “buyer” and “for sale” are used in this patent application, these terms can be interchanged with “lessor”, “lessee”, and “for lease” where relevant or applicable so as to apply to commercial leases in addition to (residential and commercial) properties for sale.

Modifications and variations to this invention will be apparent to those skilled in the art which will not depart from the spirit or scope of this invention.

1. A method comprising:
a. obtaining from a property seller (or lessor) information about a property the seller (or lessor) wishes to sell (or lease) and causing said information to be listed for sale (or for lease) on a third party website for a first duration;
b. charging the property seller (or lessor) a fee representative of having said property information listed for sale (or for lease) on said third party website for a second duration which is shorter than said first duration;
c. determining, after a time period, a third duration for which the seller (or lessor) wishes said information to remain listed for sale (or for lease) on said third party website after the expiry of the second duration; and
d. charging the property seller (or lessor) a fee representative of having said information listed for sale (or for lease) on said third party website for said third duration;
wherein said third party website does not permit the property seller (or lessor) to directly place a listing of property for sale (or for lease) on said third party website.

2. A method as in claim 1 further comprising:
a. optionally charging the property seller (or lessor) an initial fee representative of causing said information to be listed for sale (or for lease) on said third party website;
b. receiving notification that the seller (or lessor) has received an acceptable offer to buy (or lease) said property;
c. optionally charging the property seller (or lessor) a success fee representative of the fact that the property seller (or lessor) has successfully sold (or leased) the property; and
d. causing said listing of property for sale (or for lease) to be removed from said third party website.

3. The method as in claim 2 comprising the additional step of causing the contact information of the property seller (or lessor), (or optionally information on where or how to obtain the property sellers or lessors contact information) to be displayable to the general public on said third party website, and optionally to be displayed or published in a real estate board controlled or affiliated restricted printed publication(s).

4. The method as in claim 2 comprising the step of remotely providing to the property seller (or lessor) one or more of the following services:
a. advice and/or assistance in order that the property seller (or lessor) presents information in the format, level of detail and quantity required by real estate board rules and legislation in force in the location of said property, said real estate board rules and legislation in force relating to a property seller (or lessor) appointing a real estate agent to act as the representative of the property seller (or lessor) to sell (or lease) a property;
b. advice and/or assistance on how to price the property;
c. advice and/or assistance on how to list the property for sale (or for lease);
d. advice and/or assistance on how to accept, respond to, and/or make a counter offer to sell (or lease) the property; and
e. advice and/or assistance on how to accept, or respond to an offer to purchase (or lease) the property.
f. advice and/or assistance on how to ensure that the sale (or lease) is completed

5. The method as in claim 2 comprising the step of providing a means for the property seller (or lessor) to communicate remotely with a real estate agent, a real estate lawyer, or real estate consultant.

6. The method as in claim 2 where the third party website is a Multiple Listing Service (MLS) web site, Commercial Listing Service (CLS) web site, and or is connected at least in part via association, approval, affiliation, partnership, sponsorship or ownership to or by the National Association of Realtors (NAR), the Canadian Real Estate Association (CREA), or a real estate board or association representing licensed real estate agents selling (or leasing) residential, industrial, commercial, or investment properties.

7. The method as in claim 2 where the information is obtained remotely via one or more of telephone, cell phone, satellite phone, fax, email, mail, videophone and internet phone.

8. The method as in claim 2 comprising the step of causing a web address or hyperlink to said web address to be displayed on said third party website, the web address being that of a second website through which a prospective buyer (or lessee) of the property can electronically bid on or make an offer to purchase (or lease) the property. (optionally to include in the display, instructions directing potential buyers (or lessees) to click on the link, or go to the web address if they wish to make an offer or bid to purchase or lease the property).

9. The method as in claim 8, comprising the steps of:
a. determining the number of times said hyperlink has been activated; and
b. charging the property seller (or lessor) a fee proportional to said number of times said hyperlink has been activated.

10. The method of claim 8 where the second website has the provision of allowing a licensed real estate agent representing said prospective buyer (or lessee) to make a bid, or assist said prospective buyer (or lessee) to make a bid, and allowing said licensed real estate agent to receive remuneration for this service.

11. The method as in claim 2 comprising the step of supplying to the property seller (or lessor) a for sale (or for lease) sign, or supplying the property seller (or lessor) the information necessary in order to make the for sale (or for lease) sign displaying at least an alphanumeric reference number uniquely identifying the property on the third party website and a telephone number.

12. The method as in claim 11 in which a caller calling the telephone number is prompted for said reference number then given a choice of options comprising one or more of:
a. listening to pre-recorded information about the property
b. listening to pre-recorded information on how to make an online offer or bid on the property
c. downloading information about the property
d. speaking to the property seller (or lessor)
e. speaking to a real estate agent, and
f. leaving a message

13. A system comprising:
a. a computer-readable medium;
b. a server;
c. a processor;
d. a plurality of remote terminals;
e. a program residing in the computer readable medium, the program configured to:
i. display information on a remote terminal;
ii. accept inputs from said remote terminal;
iii. accept an input from a property seller (or lessor) indicating that the property seller (or lessor) wants to sell (or lease) a property;
iv. display the names of one or more third party websites on which the property can be listed and displayed for sale (or for lease); and
v. if there are two or more said third party websites listed, accept an input or inputs from the property seller (or lessor) indicating which of the third party websites should be used for listing and displaying the property for sale (or for lease);
wherein said one or more third party websites do not permit the property seller (or lessor) to directly place a listing displaying property for sale (or for lease) on said one or more third party websites.

14. The system of claim 13 wherein the property seller (or lessor) can input information about the property.

15. The system of claim 14 wherein the property seller (or lessor) is guided to input information about the property by one or more wizard or pop ups, or simply an online “guide to completing MLS forms” that can be downloaded and printed for reference.

16. The system of claim 13 wherein the program is configured, after receiving an input from the property seller (or lessor) indicating the location and type of property, to generate documents with one or more blanks to be completed by the property seller (or lessor), the documents being required by legislation and/or real estate board rules in force at the location of the property to be completed in order for the property seller (or lessor) to appoint a real estate agent as a representative of the property seller (or lessor).

17. The system of claim 13 wherein the program is configured to accept information from the property seller (or lessor) about how long the property seller (or lessor) wishes to list and display the property for sale (or for lease) on each of the third party websites and is also configured to calculate a fee proportional to the length of time the property seller (or lessor) has indicated that the property should be listed and displayed for sale (or for lease).

18. The system of claim 13 wherein the program is configured to allow the property seller (or lessor) to make an electronic payment either directly or via a third party payment processing website.

19. The system of claim 13 wherein the program is configured to permit a property seller (or lessor) to communicate via one of said remote terminals with either a real estate agent, a real estate consultant, a potential buyer (or lessee) for the property, or an agent of such buyer (or lessee), or a real estate lawyer.

20. The system of claim 13 wherein the program is configured to allow the completion of documents electronically, optionally including the signing of them digitally.

21. The system of claim 13 wherein the program is configured to transmit documents to a real estate lawyer.

22. The system of claim 13 wherein the program is configured to display information pertaining to said property on the first page it causes to be displayed, or a later page displayed, at a remote user's terminal as a result of said user activating a hyperlink displayed close to a listing displaying said property for sale (or for lease) on one of said third party websites.

23. The system of claim 23 wherein the program is configured to display the terms offered by the property seller (or lessor).

24. A for sale (or for lease) sign for advertising that a property is for sale (or for lease), the sign displaying at least a telephone number and an alphanumeric reference number identifying the property on an MLS website(s) on which it and a plurality of other properties are listed and displayed for sale (or for lease).

25. A sign as in claim 24 also displaying contact information for the seller (or lessor).

26. A sign as in claim 24 also displaying information (including a web site address) on where or how to make an online offer or bid for a property.
